(19) United States
(12) Patent Application Publication
(10) Pub. No.: US 2018/0274621 A1
(43) Pub. Date: Sep. 27, 2018

(54) DAMPING VALVE FOR SHOCK ABSORBER

(71) Applicant: Diana Maree Robertson, Queensland (AU)

(72) Inventor: Diana Maree Robertson, Queensland (AU)

(21) Appl. No.: 15/926,205

(22) Filed: Mar. 20, 2018

(30) Foreign Application Priority Data
Mar. 24, 2017 (AU) 2017901054

(51) Int. Cl. F16F 9/06

(52) U.S. Cl. CPC F16F 9/063; F16F 9/348

(57) ABSTRACT

A piston for a shock absorber, the piston including a compression chamber face, a rebound chamber face. At least one compression port extends between the compression chamber face and the rebound chamber face and at least one rebound port extends between a rebound port entry in a rebound port entry region on the rebound chamber face and a rebound port exit in a rebound port exit region on the compression chamber face. The or each compression port is substantially aligned with a primary axis of the piston and has a compression port radial location relative to the primary axis of the piston. The rebound port entry region is located at a greater radial distance from the primary axis of the piston than the compression port radial location, and the compression port radial location is at a greater radial distance from the primary axis of the piston than the rebound port exit region. This provides the easily achievable benefit of higher rebound damping than compression damping through the provision of a small pressure area under the rebound shims and a large pressure area under the compression shims.

### TECHNICAL FIELD

The present invention relates to shock absorbers for damping motions of sprung vehicles and specifically relates to a piston incorporating damper valving.

### BACKGROUND

The use of fluid filled telescopic type shock absorber for damping the motion of sprung vehicles is well known. These devices usually comprise a piston separating a cylinder into a compression chamber and a rebound chamber, the piston being connected to a rod extending out of one and of the cylinder. The compression and rebound chambers are typically filled with hydraulic fluid and a volume of gas or air is provided to absorb the volume change inside the cylinder due to rod displacements. The gas volume can be around the cylinder in an outer tube in twin-tube type shock absorbers, at one end of the cylinder in mono-tube type shock absorbers, or in a separate chamber connected to the cylinder either directly or remotely via a flexible pipe in remote-reservoir type shock absorbers. A foot valve is typically provided between the compression chamber and the gas volume controlling fluid flow there-between. The piston typically incorporates damper valving controlling flow between the compression and rebound chambers.

Most pistons include compression damping ports between the compression chamber face and the rebound chamber face of the piston, with compression damping shims on the rebound chamber face controlling flow through the compression ports. Similarly they include rebound damping ports between the rebound chamber face and the compression chamber face of the piston, with rebound damping shims on the compression chamber face controlling flow through the rebound ports. Typically the compression ports and rebound ports occupy regions of the piston faces at similar radial distances from the rod centre-line, so the compression and rebound ports are angled in opposite directions as shown for example m U.S. Pat. No. 3,882,977. In these arrangements, the compression shims and rebound shims are of similar diameter, all mounted on a spigot on the end of the rod.

However, due to the difference in area of the compression chamber face of the piston and rebound chamber face of the piston due to the cross-sectional area of the rod damping against the rebound chamber face, the area over when pressure in the rebound acts is less than the area over which the pressure in the rebound chamber acts. This works against the usual desire for ride comfort where a higher magnitude of damping is required for rebound motions than for compression motions, requiring a large imbalance between the size of the compression ports and shims compared to the rebound ports and shims. In order to overcome this, U.S. Pat. No. 7,613,490 discloses a piston and rod arrangement in which the compression flows and the rebound flows are radially separated. Rebound flow out of the rebound chamber passes into a cavity in the rod, then through to the centre of the piston before exiting the compression chamber face of the piston under rebound shims that are radially inside the ring of compression ports. This leaves large area of the compression side of the piston and all of the rebound chamber face of the piston for compression ports, so when compared to a conventional damper piston, the compression ports can be larger which can beneficially reduce minimum high speed compression damping, the compression shims can be larger area permitting lower compression damping through much of the speed range and the rebound ports and shims can be smaller to provide higher damping. However the need to pass all of the rebound flow through the centre of the rod requires a minimum diameter of rod that can be too large for smaller vehicle applications for example and can generate a large push-out force for a given pressure of gas in the gas volume, due to the cross-sectional area of the rod.

United States patent application publication number 2014/0017096 discloses a shock absorber piston and rod arrangement in which the rebound flow passes through grooves cut around the rod allowing a smaller rod to be used. However the grooves in the threaded end of the rod inside the piston can weaken the thread.

### SUMMARY OF INVENTION

According to a first aspect of the invention there is provided a piston for a shock absorber, the piston including: a compression chamber face, a rebound chamber face, a dog of compression ports extending substantial/ye axially (i.e. substantially parallel to the primary axis of the piston) between the compression chamber face and the rebound chamber face; at least one rebound port extending from a rebound port region of the rebound chamber face to a rebound port region of the compression chamber face; the rebound port region of the compression chamber face being inside (i.e. radially inside) the ring of compression ports; and characterised in that the rebound port region of the rebound chamber face is outside (i.e. radially outside) the ring of compression ports.

The rebound chamber face may include a concave section including the radial region in which the ring of compression ports is located. The compression chamber face may include a concave section including the rebound port region of the compression chamber face. Alternatively, the compression chamber face and/or the rebound chamber face may include a shim sealing ridge.

The or each rebound port may comprise a substantially radially oriented radial channel and a substantially axially oriented axial channel, the radial channel intersecting the axial channel, the axial channel exiting the compression chamber face of the piston. The radial channel may be formed by making a radial channel through the rebound chamber face of the piston, the radial channel being capped by a plate sealing the radial channel at, and forming a portion of, the rebound chamber face, the plate extending radially to at least the ring of compression ports without covering a peripheral end of the radial channel, i.e. leaving the radial channel open through the rebound chamber face of the piston towards the outer diameter of the piston. Alternatively; the radial channel may be formed by making a radial channel under the rebound chamber face of the piston, the radial channel extending from an outer diameter of the piston to the axial channel, the radial channel exiting the rebound chamber face of the piston or being intersected by a cut through the rebound port region of the rebound chamber face towards the outer diameter of the piston.

Alternatively the rebound ports may be straight, inclined (i.e. angled relative to a primary axis of the piston) channels formed in the piston. These can be easily machined or formed as part of a molded piston such as a sintered piston.

One or more aspects of the present invention may provide a shock absorber including a piston, the piston including: a compression chamber face, a rebound chamber face, a ring of compression ports extending substantially axially between the compression chamber face and the rebound chamber face; at least one rebound port extending from a rebound port region of the rebound chamber face to a rebound port region of the compression chamber face; the rebound port region of the compression chamber face being inside (i.e. radially inside) the ring of compression ports; and characterised in that the rebound port region of the rebound chamber face is outside (i.e. radially outside) the ring of compression ports. The shock absorber may further include: a cylinder, a rod and a reservoir including a gas volume; the cylinder having a bore; the piston being slidably located in the bore and forming a compression chamber within the bore adjacent the compression chamber face of the piston and forming a rebound chamber within the bore adjacent the rebound chamber face of the piston; the rod being fixed to the piston and extending through the rebound chamber.

The shock absorber may further include compression shims, the compression shims including at least a first compression shim clamped against or resiliently preloaded toward the rebound chamber face of the piston. The first compression shim may be a bleed shim including a slot, the compression shims including at least a second compression shim. The compression shims may be resiliently preloaded toward the rebound chamber face of the piston by a spring such as a coil spring or Belleville washer. The piston may be located on a spigot on the end of the rod, the spigot including an external thread and the piston including an internal thread, the internal thread being engaged with the external thread to directly or indirectly clamp or resiliently preload the compression shims toward the rebound chamber face of the piston by a shoulder on the rod.

The shock absorber may further include rebound shims, the rebound shims including at least a first rebound shim clamped or resiliently preloaded toward the compression chamber face of the piston. The first rebound shim may be a bleed shim including a slot, the rebound shims including at least a second rebound shim. The rebound shims may be resiliently preloaded toward the compression chamber face of the piston by a spring such as a coil spring or Belleville washer. A fastener may be fastened to the rod or the piston to clamp or resiliently preload the rebound shims toward the compression chamber face of the piston.

The reservoir may be an external reservoir in direct or indirect (for example through a foot valve) fluid communication with the compression chamber, for example by a conduit, the reservoir including the gas volume.

The reservoir may be within the cylinder at an opposite end of the cylinder to the rebound chamber, the reservoir including a reservoir piston and the gas volume, the reservoir piston being slidably located in the bore and having a compression chamber face and a gas volume face, the compression chamber face being in fluid communication with the compression chamber and the gas volume face forming a movable wall of the gas volume.

The shock absorber may further include an outer tube around the cylinder forming the reservoir in an annular gap between the cylinder and the outer tube, the reservoir including the gas volume.

A piston for a shock absorber, the piston including: a compression chamber face, a rebound chamber face, at least one compression port extending between the compression chamber face and the rebound chamber face and at least one rebound port extending between a rebound port entry in a rebound port entry region on the rebound chamber face and a rebound port exit in a rebound port exit region on the compression chamber face: the or each compression port being substantially aligned with a primary axis of the piston and having a compression port radial location relative to the primary axis of the piston; wherein the rebound port entry region is located at a greater radial distance from the primary axis of the piston than the compression port radial location; and the compression port radial location is at a greater radial distance from the primary axis of the piston than the rebound port exit region. The rebound port may include a radial channel and an axis channel. Alternatively, the rebound ports may be oriented at an inclined angle relative to the primary axis of the piston.

It will be convenient to further describe the invention by reference to the accompanying drawings which illustrate preferred aspects of the invention. Other embodiments of the invention are possible and consequently particularity of the accompanying drawings is not to be understood as superseding the generality of the preceding description of the invention.

### BRIEF DESCRIPTION OF DRAWINGS

In the drawings:

FIG. 1 is a cross sectional view of an external reservoir type shock absorber accordion to the present invention.

FIG. 2 is a cross sectional view of a potion of the shock absorber of FIG. 1.

FIG. 3 as a perspective view of the piston and rod assembly from the shock absorber of FIG. 1.

FIG. 4 is an exploded view of the piston and rod assembly assembly of FIG. 3.

FIG. 5 is a perspective view of the piston of FIG. 4.

FIG. 6 is a perspective view of the piston of FIG. 4.

FIG. 7 is a cross sectional view of tie piston of FIG. 4.

FIG. 8 is a cross sectional view of a portion of a twin tube type shock absorber according to the present invention.

FIG. 9 is a perspective view of the piston and rod assembly of FIG. 8.

FIG. 10 is an exploded view of the piston and rod assembly of FIG. 9.

FIG. 11 is a perspective view of the piston of FIG. 10.

FIG. 12 is a perspective view of the piston of FIG. 10.

FIG. 13 is a cross sectional view of the piston of FIG. 10.

FIG. 14 is a cross sectional view of a portion of shock absorber including a piston according to the present invention.

FIG. 15 is a cross sectional view of a mono-tube type shock absorber according to the present invention, incorporating the piston of FIG. 14.

### DESCRIPTION OF PREFERRED EMBODIMENT

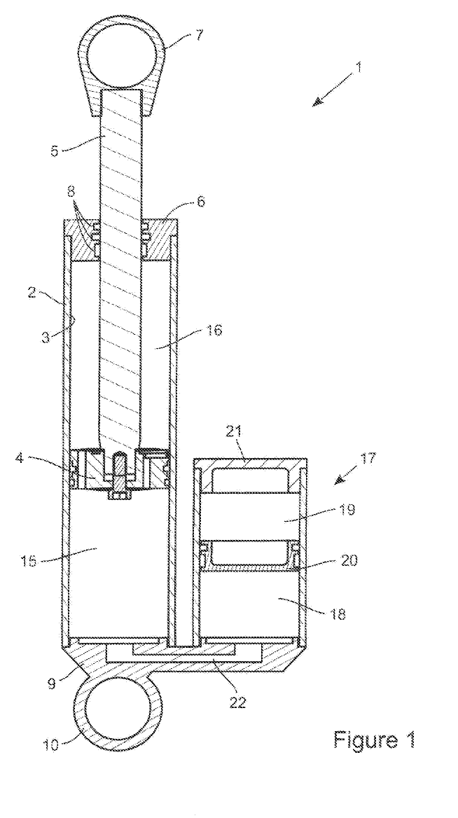

Referring initially to FIG. 1, there is shown a shock absorber 1, including cylinder 2 having bore 3. Piston 4 slides within the bore and is connected to rod 5. The rod protrudes through a rod guide cap 6 at one end of the cylinder and is terminated in a fixing into which a resilient bushing (not shown) is pressed. The rod guide cap 6 includes grooves 8 for a bearing, a seal and a rod wiper (not shown). The opposite end of the cylinder is closed by a fixing cap 9 including a fixing ring 10 into which a resilient bushing (not shown) is pressed. The piston 4 divides the volume within the cylinder 2 into a compression chamber 15 and a rebound chamber 16. The compression chamber 15 decreases in volume with contraction of the shock absorber, i.e. with a reduction in the distance between the fixing 7 on the rod and the fixing 10 on the cylinder. The rebound chamber 16 decreases in volume with extension of the shock absorber, i.e. with an increase in the distance between the fixing 7 on the rod and the fixing 10 on the cylinder. Both the compression chamber and the rebound chamber are fluid-filled.

The shock absorber 1 shown in FIG. 1 is of the external reservoir type, having a cylindrical external reservoir 17 divided into a liquid chamber 18 and a gas chamber or gas volume 19 by a piston 20. The external reservoir has an end cap 21 which can be fitted with a charging valve to enable the gas charge in the reservoir to be adjusted. The fixing cap 9 includes a passageway 22 between the compression chamber 15 and the liquid chamber 18 in the external reservoir. The passageway 22 between the cylinder 2 and the reservoir 17 can include valving (not shown) or a valve arrangement (not shown) at either end of the passageway, if the external reservoir or mounted remotely, i.e. not rigidly mounted to the fixing cap of the shock absorber, then the passageway can be replaced by a flexible conduit.

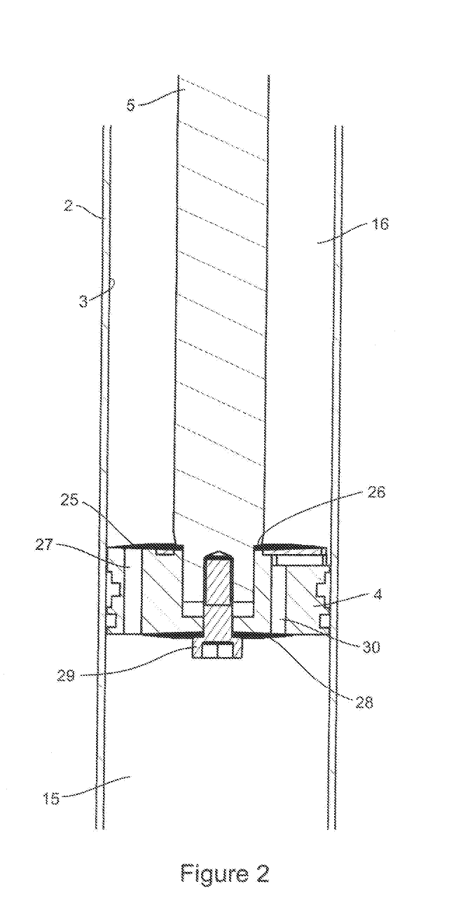

The central portion of the shock absorber around the piston 4 can be seen in more detail in FIG. 2. Throughout the drawings, equivalent features are allotted like reference numerals. Compression shims 25 are clamped into the concave section of the rebound chamber face of the piston towards the centre by the shoulder 26 on the rod and restrict communication between the compression port 27 and the rebound chamber 16. The greater the pressure difference between the high pressure fluid in the compression chamber 15 and the lower pressure fluid in the rebound chamber 16 during a contraction motion of the shock absorber, the greater the deflection of the compression shims 25. Rebound shims 28 are clamped into the concave section of the compression chamber face of the piston towards the centre by the fastener 29 screwed into the end of the rod and restrict communication between the rebound port 30 and the compression chamber 15. The greater the pressure difference between the high pressure fluid in the rebound chamber 18 and the lower pressure fluid in the compression chamber 15 during an extension motion of the shook absorber, the greater the deflection of the rebound shims 28.

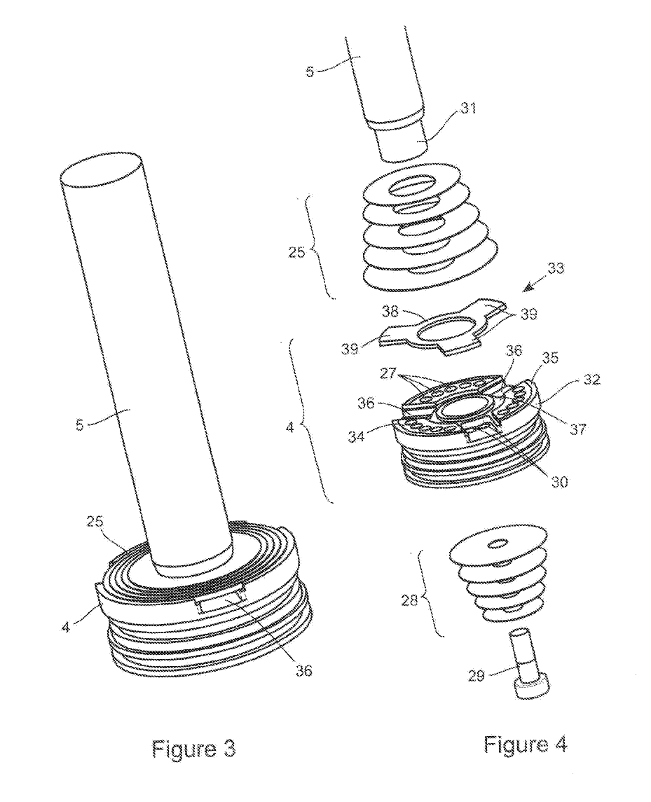

The piston rod assembly can be seen in FIG. 3 and with the parts exploded apart for clarity in FIG. 4. The piston 4 can be threaded onto the rod 5 or located on a spigot 31 on the end of the rod and held on by the fastener 29. Any number of compression shims 25 and rebound shims 28 can be used depending on their thickness and diameter and the stiffness characteristics required. The piston itself is formed from two components, the main body 32 and a plate 33 which can be seen in FIG. 4, as can the concave section 34 of the rebound chamber face 35 of the piston 4 including the ring of compression ports 27. Into the rebound chamber face 35 are cut (or otherwise formed) radial channels 36, joined by a central ring 37. The plate 33 has a ring portion 38 from which radiates the same number of fingers 39 as the number of radial channels 36 in the rebound chamber face 35 of the piston main body 32. The radial channels 36 are stepped, so the plate 33 can be located at the rebound chamber face 35 and so that the deeper portions of the radial channels allow the ends of the rebound ports 30 to remain open under the plate when the plate 32 is capping the channels.

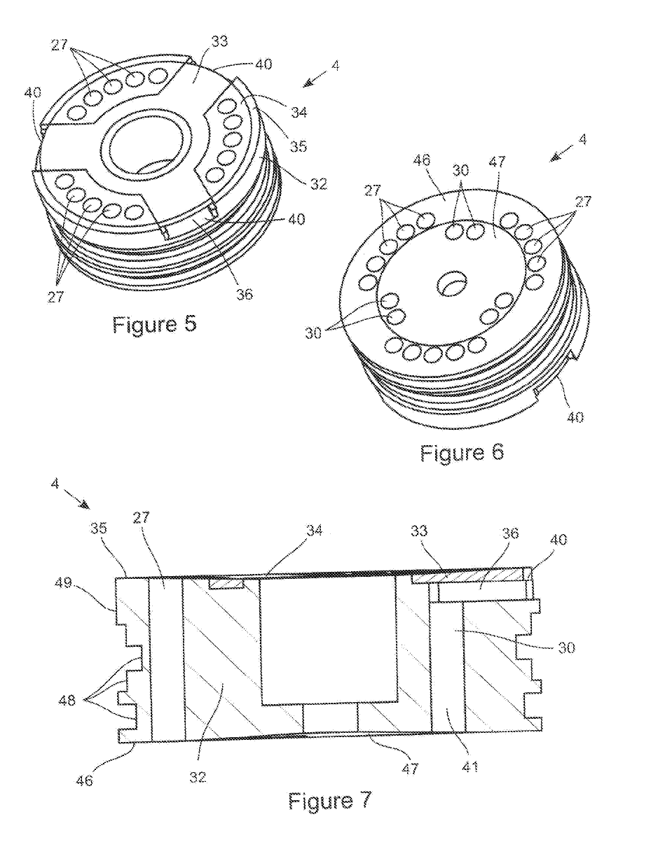

FIG. 5 shows the piston 4 once manufactured, with the plate 33 now fixed (typically by welding or brazing) into the tops of the radial channels 36, so that the radial channels 36 are sealed through the concave section of the rebound chamber face of the piston 4, but remain open at the peripheral ends 40 toward the outer diameter of the piston. The concave section 34 of the rebound chamber face 35 of the piston 4 is preferably machined after the plate 33 is fixed to cap the top of the radial channels 36 to ensure the concave surface is smooth enough for the compression shims to seat against effectively to provide, a reliable, repeatable restriction between pistons, repeatability being essential for volume manufacture. The rebound port 30 flow path across the piston 4 can be seen in the cross-section in FIG. 7, with the, axial channel 41 connecting to the radial channel 36 which is then open at its peripheral end 40, but closed for much of the top towards the centre by the plate 33 capping the channel 36. In use, compression shims seat into the concave section 34 of the rebound chamber or 35, with the ring around the outside of the compression shims or around the outside of the concave section of the rebound chamber face being a rebound port region of the rebound chamber face. The peripheral end 40 of the radial channels 36 of the rebound ports is within this rebound port region of the rebound chamber face, i.e. with reference to FIG. 2, rebound now fluid from the rebound chamber 16 passes between the compression shims 25 and the bore 3 of the cylinder 2 into the radial channels of the rebound ports 30 and on through the axial channel of the rebound ports 30 to the compression chamber face of the piston under the rebound shims 28, which deflect in dependence on pressure difference across them, letting the rebound flow into the compression chamber 15.

The compression chamber face 46 of the piston 4 can be seen in FIG. 6 with the ring of compression ports 27 radially outside the rebound ports 30. The concave section 47 of the compression chamber face 46 of the piston 4 is only shown of a similar outer diameter to the rebound shims, i.e. up to or past the outside of the rebound ports 30 which is the minimum required, although the concave section 47 can extend across the entire compression chamber face of the piston. Clearly the rebound shims cannot block the compression ports 27.

The rebound port region of the compression chamber face of the piston is at least an annular ring encompassing the rebound ports 30, but can at its largest be the concave section 47 of the compression chamber face 46 up to the outside of the largest rebound shim used, or up to the inside edge of the ring of compression ports 27. Referring again now to FIG. 7, grooves 48 are incorporated into the outer diameter 49 of the piston 4 to accommodate bearing material and/or seals.

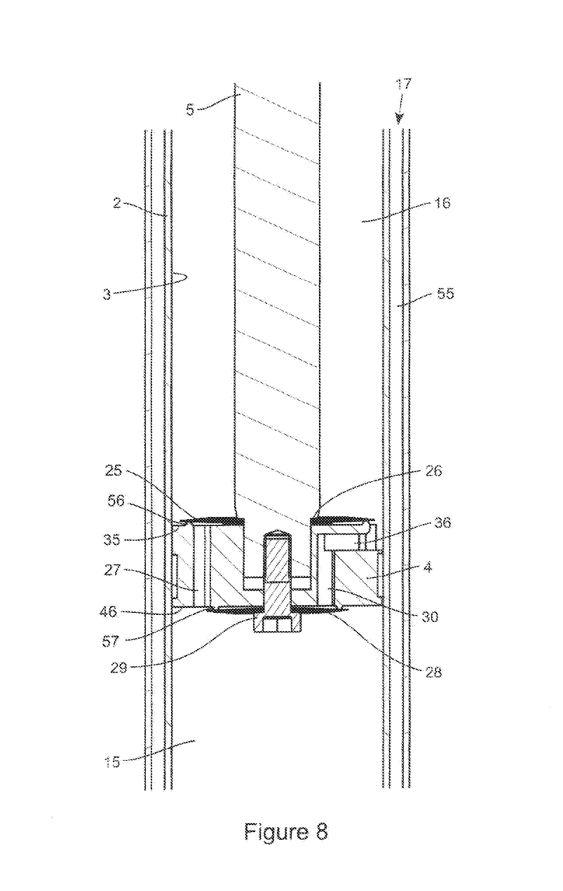

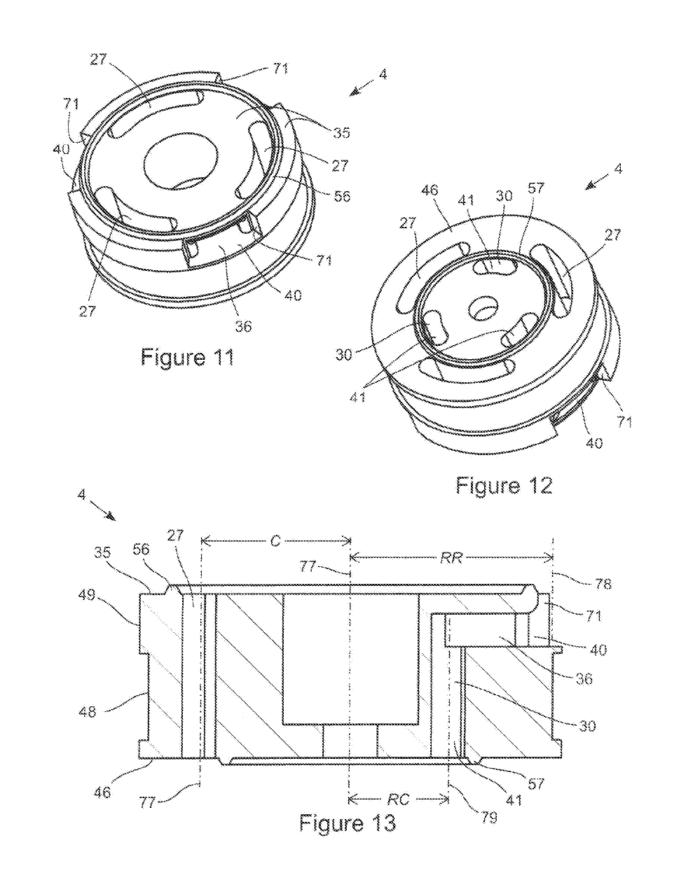

FIGS. 8 to 13 show elements of a similar shock absorber, but of the twin-tube type, i.e. in FIG. 8 there is an outer tube 54 creating an annular volume 55 between the cylinder 2 and the outer tube 54, the annular volume forming the reservoir which is part filled with oil and part filled with gas, as is well known in the art. The structure of the piston 4 is also different to the previous embodiment. The compression chamber face 46 and the rebound chamber face 35 do not include respective concave sections, but shim sealing ridges 57 and 56 into which the shims are preloaded. The piston is also formed as one piece, with the radial channel portion 36 of the rebound port 30 being cut into the piston, or formed by a movable plug in the mold if the piston is of sintered construction, as is well known.

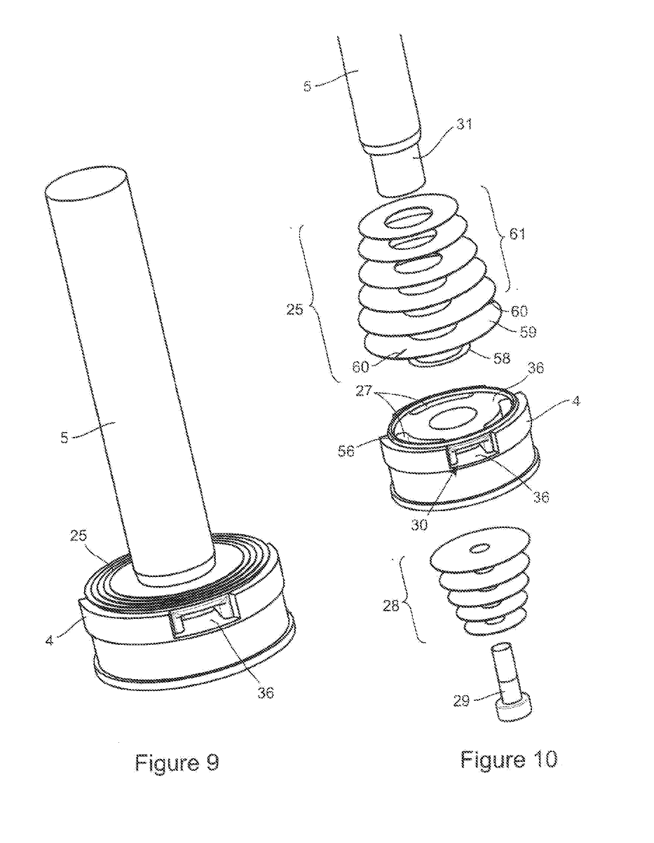

The piston rod assembly of this arrangement can be seen in FIG. 9 and compression shims to operate properly. Therefore, the rebound port entry region must be located at a greater radial distance from the primary axis of the piston than the compression port radial location (or annular area) which in turn must be located at a greater radial distance from the primary axis of the piston than the rebound port exit region.

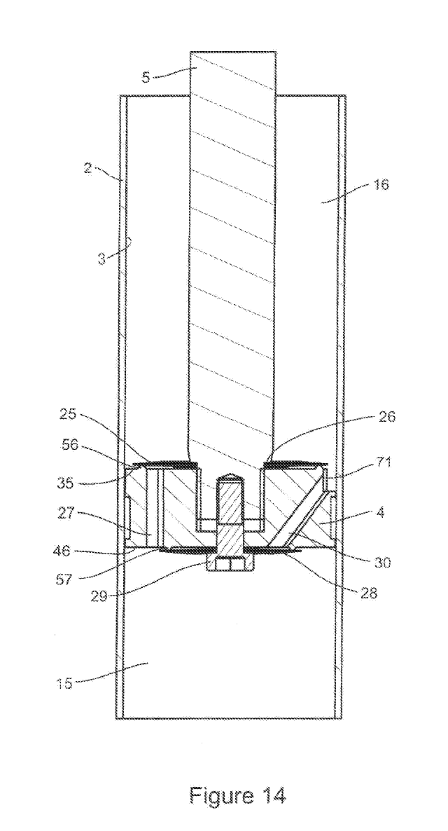

The piston in FIG. 14 has rebound ports 30 that are straight path channels inclined at an angle relative to the compression ports (and relative to the primary axis of the piston) and comprising a single drilling or ideally a curved section mold core. To reduce the restriction into the rebound port 30, a cut 71 can again be made through the rebound port region of the rebound chamber face of the piston, providing a wider entrance into the angled rebound port 30 from the rebound chamber 16.

Although the fastener 29 is shown screwed into the end of the rod in the embodiments shown in FIGS. 2 and 8, it can optionally be screwed into the piston if the piston is screwed onto the rod as shown in FIG. 14 using an external thread on the spigot on the rod and an internal thread in the piston. However it can be preferable, as also shown in FIG. 14, to screw both the piston onto the rod and the fastener into the end of the rod.

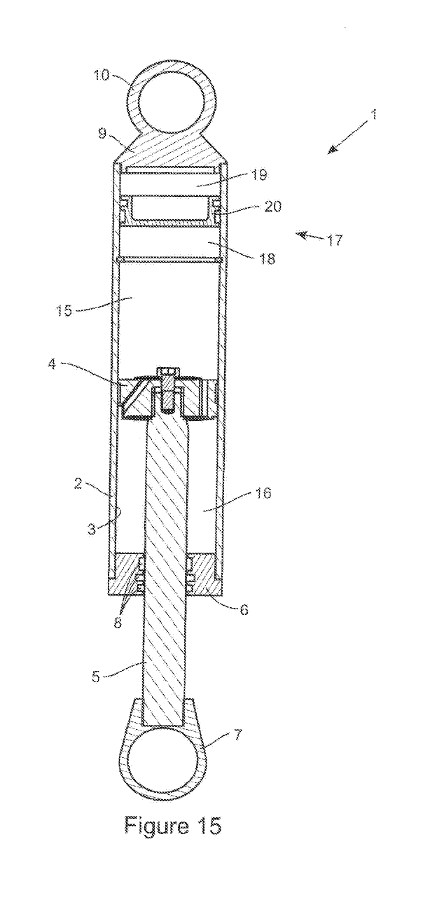

The piston of FIG. 14 is shown in a mono-tube type shock absorber in FIG. 15, where the reservoir 17 is incorporated into the end of the cylinder 2. The ring 81 between the compression chamber 15 and the liquid chamber 18 of the reservoir 17 can be omitted or can be exchanged for a valve body and shims as is known.

In all of the illustrated examples of the present invention, it can be seen that it is straightforward to achieve the usual requirement for higher rebound damping forces than compression damping forces through the provision of a small pressure area under the rebound shims and a large pressure area under the compression shims and through compression ports that can easily be significantly larger in cross-sectional area than the rebound ports. Indeed, since the compression chamber face of the piston is larger than the rebound chamber face of the piston (essentially by the area of the rod) the need to easily achieve smaller area rebound ports and a smaller pressure area under the rebound shims compared respectively to the area of the compression ports and pressure area under the compression shims can be easily appreciated, even if similar magnitude compression and rebound forces are required.

Modifications and variations as would be apparent to a skilled addressee are deemed to be within the scope of the present invention.

1. A piston for a shock absorber, the piston including a compression chamber face, a rebound chamber face, a ring of compression ports extending substantially axially between the compression chamber face and the rebound chamber face,
at least one rebound port extending from a rebound port region of the rebound chamber face to a rebound port region of the compression chamber face,
the rebound port region of the compression chamber face being inside the ring of compression ports; and characterised in that
the rebound port region of the rebound chamber face is outside the ring of compression ports.

2. A piston according to claim 1 wherein the rebound chamber face includes a concave section including the radial region in which the ring of compression ports is located.

3. A piston according to claim 1 wherein the compression chamber face includes a concave section including the rebound port region of the compression chamber face.

4. A piston according to claim 1 wherein the compression chamber face and/or the rebound chamber face includes a shim sealing ridge.

5. A piston according to claim 1 wherein the or each rebound port comprises a substantially radially oriented radial channel and a substantially axially oriented axial channel, the radial channel intersecting the axial channel,
the axial channel exiting the compression chamber face of the piston.

6. A piston according to claim 5 wherein the radial channel is formed by making a radial channel through the rebound chamber face of the piston, the radial channel being capped by a plate sealing the radial channel at, and forming a portion of, the rebound chamber face,
the plate extending radially to at least the ring of compression ports without covering a peripheral end of the radial channel.

7. A piston according to claim 5 wherein the radial channel is formed by making a radial channel under the rebound chamber face of the piston, the radial channel extending from an outer diameter of the piston to the axial channel
the radial channel exiting the rebound chamber face of the piston or being intersected by a cut through the rebound port region of the rebound chamber face.

8. A piston according to claim 1 wherein the rebound ports are straight, inclined channels formed in the piston.

9. A shock absorber including the piston of claim 1, the shock absorber further including a cylinder, a rod and a reservoir including a gas volume,
the cylinder having a bore, the piston being slidably located in the bore and forming a compression chamber within the bore adjacent the compression chamber face of the piston and forming a rebound chamber within the bore adjacent the rebound chamber face of the piston,
the rod being fixed to the piston and extending through the rebound chamber.

10. A shock absorber according to claim 9 further including compression shims, the compression shims including at least a first compression shim clamped or resiliently preloaded against the rebound chamber face of the piston.

11. A shock absorber according to claim 10 wherein the piston is located on a spigot on the end of the rod, the spigot including an external thread and the piston including an internal thread, the internal thread being engaged with the external thread to clamp or resiliently preload the compression shims toward the rebound chamber face of the piston by a shoulder on the rod.

12. A shock absorber according to claim 9 further including rebound shims, the rebound shims including at least a first rebound shim clamped or resiliently preloaded toward the compression chamber face of the piston.

13. A shock absorber according to claim 12 wherein the rebound shims are damped resiliently preloaded toward the compression chamber face of the piston by a fastener fastened to the rod or the piston.

14. A shock absorber according to claim 9 wherein the reservoir is an external reservoir in fluid communication with the compression chamber, the reservoir including the gas volume.

15. A shock absorber according to claim 9 wherein the reservoir is within the cylinder at an opposite end of the cylinder to the rebound chamber, the reservoir including a reservoir piston and the gas volume,
the reservoir piston being slidably located in the bore and having a compression chamber face and a gas volume face, the compression chamber face being in fluid communication with the compression chamber and the gas volume face forming a movable wall of the gas volume.

16. A shock absorber according to claim 9 further including an outer tube around the cylinder forming the reservoir in an annular gap between the cylinder and the outer tube, the reservoir including the gas volume.

17. A piston for a shock absorber, the piston including a compression chamber face, a rebound chamber face, at least one compression port extending between the compression chamber face and the rebound chamber face and at least one rebound port extending between a rebound port entry in a rebound port entry region on the rebound chamber face and a rebound port exit in a rebound port exit region on the compression chamber face,
the or each compression port being substantially aligned with a primary axis of the piston and having a compression port radial location relative to the primary axis of the piston, wherein
the rebound port entry region is located at a greater radial distance from the primary axis of the piston than the compression port radial location, and
the compression port radial location is at a greater radial distance from the primary axis of the piston than the rebound port exit region.

18. A piston according to claim 17 wherein the rebound ports are oriented at an inclined angle relative to the primary axis of the piston.
